(19) United States
(12) Patent Application Publication
(10) Pub. No.: US 2017/0129483 A1
(43) Pub. Date: May 11, 2017

(54) AUTOMATIC PARKING SYSTEM

(71) Applicant: Leauto Intelligent Technology (BEIJING) Co. Ltd, Chaoyang District Beijing (CN)

(72) Inventors: Wenrui LI, Chaoyang District Beijing (CN); Yong XU, Chaoyang District Beijing (CN); Yu ZOU, Chaoyang District Beijing (CN); Kunsheng CHEN, Chaoyang District Beijing (CN); Wei LIN, Chaoyang District Beijing (CN); Peng LIU, Chaoyang District Beijing (CN); Dan LI, Chaoyang District Beijing (CN); Xiaofei GOU, Chaoyang District Beijing (CN)

(21) Appl. No.: 14/964,678

(22) Filed: Dec. 10, 2015

(30) Foreign Application Priority Data
Nov. 9, 2015 (CN) 201510760675.0

(51) Int. Cl. B60W 30/06; G08G 1/14

(52) U.S. Cl. CPC B60W 30/06; G08G 1/146; G07B 15/02

(57) ABSTRACT

The present disclosure provides an automatic parking system. The system comprises a data acquisition unit, a central processing unit and a vehicle control unit, wherein the data acquisition unit and the central processing unit are arranged in a parking lot, the vehicle control unit is arranged on a vehicle, and the central processing unit is respectively in communication connection with the data acquisition unit and the vehicle control unit. The data acquisition unit acquires environmental data around the vehicle, and sends the environmental data to the central processing unit; the vehicle control unit sends a parking request to the central processing unit and controls the vehicle according to received control instructions; and the central processing unit receives the parking request and the environmental data, generates the control instructions according to the environmental data and sends the control instructions to the vehicle control unit.

### CROSS-REFERENCE TO RELATED APPLICATIONS

The present disclosure is based upon and claims priority to Chinese Patent Application No. 201510760675.0, filed on Nov. 09, 2015, the entire contents of which are incorporated herein by reference.

### FIELD OF TECHNOLOGY

The present disclosure relates to the technical field of vehicles, and particularly relates to an automatic parking system.

### BACKGROUND

For a driver, because the urban parking space is limited, how to quickly and accurately drive a car to a narrow space has become a necessary skill. Poor parking skill may lead to traffic jam, nerve fatigue, vehicle rubbing and the like. With the progress of technology, an automatic parking function appears. The automatic parking indicates that a car is automatically parked in place without manual control.

In the prior art, the automatic parking system is installed on a vehicle, and generally includes a data acquisition unit, a central processing unit and a vehicle control unit, wherein the data acquisition unit acquires environmental data around the vehicle, the central processing unit analyzes the acquired data, and the vehicle control unit automatically controls the vehicle according to the analysis result, so that the vehicle is driven to the specified parking place and the automatic parking function is realized.

However, the prior art at least has the following problem: the automatic parking function can be realized by installing an automatic parking system in each vehicle, so the parking cost is relatively high.

### SUMMARY

The embodiment of the present disclosure provides an automatic parking system for reducing the parking cost.

To achieve the above object, the embodiment of the present disclosure adopts the following technical solution:

On the one hand, the embodiment of the present disclosure provides an automatic parking system, including a data acquisition unit, a central processing unit and a vehicle control unit, wherein the data acquisition unit and the central processing unit are arranged in a parking lot, the vehicle control unit is arranged on a vehicle, and the central processing unit is respectively in communication connection with the data acquisition unit and the vehicle control unit. The data acquisition unit is used for acquiring environmental data around the vehicle and sending the environmental data to the central processing unit; the vehicle control unit is used for sending a parking request to the central processing unit and controlling the vehicle according to received control instructions; and the central processing unit is used for receiving the parking request and the environmental data, generating the control instructions according to the environmental data and sending the control instructions to the vehicle control unit.

According to the automatic parking system provided by the present disclosure, automatic parking can be realized by only installing the vehicle control unit on each vehicle, so the parking cost is reduced for a vehicle user. In addition, the data acquisition unit and the central processing unit which are arranged in the parking lot can intensively manage a few or dozens of parking places, and a plurality of data acquisition units and central processing units are not needed, so the parking cost is also reduced for the vehicle user and a parking lot operator on the whole.

### BRIEF DESCRIPTION OF THE DRAWINGS

FIG. 1 is a structural block diagram of an embodiment of an automatic parking system provided by the present disclosure;

FIG. 2 is a scene schematic diagram of the automatic parking system of the embodiment shown in FIG. 1.

### DESCRIPTION OF THE EMBODIMENTS

The automatic parking system of the embodiment of the present disclosure will be described in detail below in combination with the accompanying drawings.

### Embodiment I

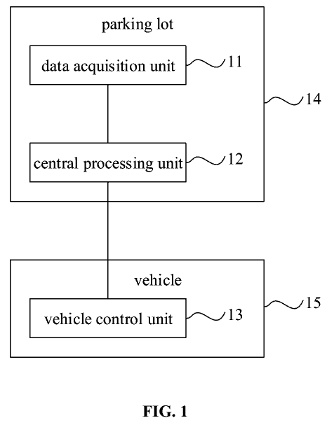

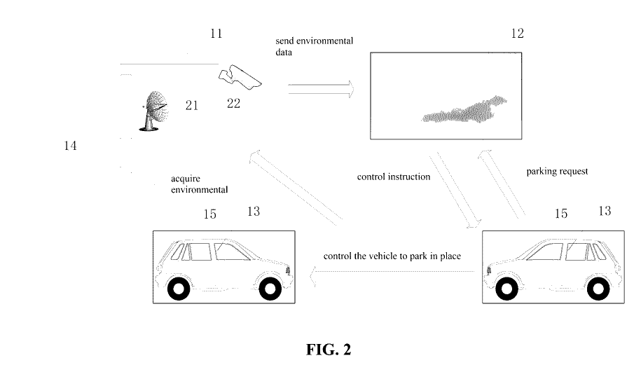

FIG. 1 is a structural block diagram of an embodiment of an automatic parking system provided by the present disclosure, and FIG. 2 is a scene schematic diagram of the automatic parking system of the embodiment shown in FIG. 1. As shown in FIG. 1 and FIG. 2, the automatic parking system of the embodiment of the present disclosure specifically may include a data acquisition unit 11, a central processing unit 12 and a vehicle control unit 13.

The data acquisition unit 11 and the central processing unit 12 are arranged in a parking lot 14, the vehicle control unit 13 is arranged on a vehicle 15, and the central processing unit 12 is respectively in communication connection with the data acquisition unit 11 and the vehicle control unit 13.

Specifically, the central processing unit 12 may be in communication connection with the data acquisition unit 11 and the vehicle control unit 13 in a wired or wireless manner. The data acquisition unit 11 and the central processing unit 12 serve as basic facilities of the parking lot 14, and automatic parking can be realized by only installing the vehicle control unit 13 in each vehicle 15, so the parking cost is greatly reduced for a vehicle user; for a parking lot operator, although partial cost is increased by providing the central processing unit 12 and the data acquisition unit 11, the data acquisition unit 11 and the central processing unit 12 can intensively manage a few or dozens of parking places, and a plurality of data acquisition units 11 and central processing units 12 are not needed, so the parking cost is also reduced for the vehicle user and the parking lot operator on the whole.

Further, the data acquisition unit 11 is used for acquiring environmental data around the vehicle 15 and sending the environmental data to the central processing unit 12. The vehicle control unit 13 is used for sending a parking request to the central processing unit 12 and controlling the vehicle 15 according to received control instructions. The central processing unit 12 is used for receiving the parking request and the environmental data, generating the control instructions according to the environmental data and sending the control instructions to the vehicle control unit 13.

Specifically, the automatic parking system of the embodiment of the present disclosure realizes the automatic parking function as follows: after the vehicle 15 enters the parking lot 14, the vehicle control unit 13 sends a parking request to the central processing unit 12; the data acquisition unit 11 acquires environmental data around the vehicle 15 in real time, and sends the environmental data to the central processing unit 12 in real time; the central processing unit 12 receives the parking request sent by the vehicle control unit 13 and the environmental data sent by the data acquisition unit 11, uniformly processes the environmental data, plans an optimal parking place, generates the control instructions according to the environmental data and sends the control instructions to the vehicle control unit 13; the vehicle control unit 13 receives the control instructions sent by the central processing unit 12, analyzes the control instructions, and performs corresponding control on the vehicle 15 according to the control instructions; and the above processes are repeated while update of the environmental data and change of the control instruction are continuously performed, and the vehicle 15 is gradually parked in the desired parking place, to realize the automatic parking function.

Further, the environmental data acquired by the data acquisition unit 11 specifically may include but not limited to position data of the vehicle 15, parking place idle data, distance data between the vehicle 15 and surrounding objects and/or traffic sign data, wherein the traffic sign data specifically may include but not limited to parking place boundary data and/or left and right turning indicating data.

Further, the control instruction generated by the central processing unit 12 specifically may include but not limited to advancing instruction, reversing instruction, left turning instruction, right turning instruction, steering wheel turning angle instruction and/or speed instruction.

Further, the data acquisition unit 11 specifically may include such sensor equipment as radar 21 (as shown in FIG. 2) and/or a camera 22 (as shown in FIG. 2) and the like. Because the radar 21 is relatively expensive, the parking cost may be greatly reduced by providing the data acquisition unit 11 in the parking lot 14. The data acquisition unit 11 is arranged in the parking lot 14, so that the installation position and height of the radar 21 and/or the camera 22 are no longer limited by the height of the vehicle 15 and are more flexible, better visual field can be provided, then a better guiding route for parking in place can be provided, and rubbing in the automatic parking process is avoided.

Further, the vehicle control unit 13 specifically may include at least one electronic control unit (ECU), which is generally referred to as a ‘travelling computer’, a ‘vehicle-mounted computer’ and the like.

According to the automatic parking system of the embodiment of the present disclosure, automatic parking can be realized by only installing the vehicle control unit on each vehicle, so the parking cost is reduced for the vehicle user; in addition, the data acquisition unit and the central processing unit which are arranged in the parking lot can intensively manage a few or dozens of parking places, and a plurality of data acquisition units and central processing units are not needed, so the parking cost is also reduced for the vehicle user and the parking lot operator on the whole.

Those of ordinary skill in the art could understand that all of or part of the steps of the above method embodiments may be completed by program instruction related hardware. The program may be stored in a computer readable storage medium. When the program is executed, the steps of the method embodiments are executed; and the storage medium includes various media capable of storing program codes, such as an ROM (Read-Only Memory), an RAM (Random Access Memory), a disk or an optical disk and the like.

Finally, it should be noted that, the above embodiments are merely used for illustrating the technical solutions of the present disclosure, rather than limiting the present disclosure. Although the present disclosure is illustrated in detail with reference to the aforementioned embodiments, it should be understood by those of ordinary skill in the art that modifications may still be made on the technical solutions disclosed in the aforementioned respective embodiments, or equivalent substitutions may be made to part of or all of the technical characteristics thereof; and these modifications or substitutions do not make the essence of the corresponding technical solutions depart from the scope of the technical solutions of the respective embodiments of the present disclosure.

What is claimed is:

1. An automatic parking system, comprising a data acquisition unit, a central processing unit and a vehicle control unit, wherein
the data acquisition unit and the central processing unit are arranged in a parking lot, the vehicle control unit is arranged on a vehicle, and the central processing unit is respectively in communication connection with the data acquisition unit and the vehicle control unit;
the data acquisition unit is used for acquiring environmental data around the vehicle and sending the environmental data to the central processing unit;
the vehicle control unit is used for sending a parking request to the central processing unit and controlling the vehicle according to received control instructions; and
the central processing unit is used for receiving the parking request and the environmental data, generating the control instruction according to the environmental data and sending the control instructions to the vehicle control unit.

2. The system of claim 1, wherein the environmental data comprises position data of the vehicle, parking place idle data, distance data between the vehicle and surrounding objects and/or traffic sign data.

3. The system of claim 2, wherein the traffic sign data comprises parking place boundary data and/or left and right turning indicating data.

4. The system of claim 1, wherein the control instructions comprise an advancing instruction, a reversing instruction, a left turning instruction, a right turning instruction, a steering wheel turning angle instruction and/or a speed instruction.

5. The system of claim 1, wherein the data acquisition unit comprises radar and/or a camera.

6. The system of claim 1, wherein the vehicle control unit comprises at least one electronic control unit (ECU).
